(19) United States
(12) Patent Application Publication
(10) Pub. No.: US 2026/0279247 A1
(43) Pub. Date: Sep. 17, 2026

(54) DRIVING CIRCUIT, DRIVING METHOD, AND DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Bo Wang, Beijing (CN); Kangpeng Dang, Beijing (CN); Cheng Zuo, Beijing (CN); Hong Chen, Beijing (CN); Xiong Guo, Beijing (CN); Kuan Li, Beijing (CN); Zhongli Luo, Beijing (CN); Xingyu Pu, Beijing (CN); Yuhong Sun, Beijing (CN); Yuansheng Tang, Beijing (CN); Hebing Xu, Beijing (CN)

(21) Appl. No.: 18/868,673

(22) PCT Filed: Sep. 27, 2023
(86) PCT No.: PCT/CN2023/121866

§ 371 Date: Nov. 22, 2024

(51) Int. Cl. G09G 3/20; G06F 3/041

(52) U.S. Cl. CPC G09G 3/2096; G06F 3/04184; G09G 2310/0275; G09G 2310/08; G09G 2320/0247; G09G 2330/023

(57) ABSTRACT

A driving circuit, a driving method and a display device are provided, which relate to the field of display technology. The driving circuit is used to drive a source driving circuit, and the driving circuit includes: a power switching sub-circuit, electrically connected to a touch power terminal and a display power terminal, where the power switching sub-circuit is configured to output a touch power signal from the touch power terminal or a display power signal from the display power terminal based on a signal output state of the touch power terminal and a signal output state of the display power terminal; and a power control sub-circuit, electrically connected to the power switching sub-circuit and the source driving circuit, where the power control sub-circuit is configured to output a source power signal to the source driving circuit under the drive of the touch power signal or the display power signal.

### CROSS-REFERENCE TO RELATED APPLICATION(S)

This application is a Section 371 National Stage Application of International Application No. PCT/CN2023/121866, filed on Sep. 27, 2023, entitled “DRIVING CIRCUIT, DRIVING METHOD, AND DISPLAY DEVICE”, the content of which is incorporated herein by reference in its entirety.

### TECHNICAL FIELD

The present disclosure relates to the field of display technology, and in particular to a driving circuit, a driving method and a display device.

### BACKGROUND

In-cell touch display screen is a design that combines a display technology and a touch technology to achieve an integration of a touch panel and a display panel. Such design may reduce an impact of display noise on touch and improve touch performance.

In such design of combination, a source driving circuit may participate in an operating process of the display panel and the touch panel, and the source driving circuit is powered by a display power supply. When the display panel is not in operation, the display power supply may not supply power, resulting in that the source driving circuit fails to operate normally, and thus the touch panel fails to operate normally.

### SUMMARY

The present disclosure provides a driving circuit, a driving method and a display device.

According to a first aspect, the present disclosure provides a driving circuit for driving a source driving circuit, including: a power switching sub-circuit, electrically connected to a touch power terminal and a display power terminal, where the power switching sub-circuit is configured to output a touch power signal from the touch power terminal or a display power signal from the display power terminal based on a signal output state of the touch power terminal and a signal output state of the display power terminal; and a power control sub-circuit, electrically connected to the power switching sub-circuit and the source driving circuit, where the power control sub-circuit is configured to output a source power signal to the source driving circuit under the drive of the touch power signal or the display power signal.

For example, the power switching sub-circuit is configured to: output the display power signal in response to determining that the touch power signal and the display power signal are received; output the touch power signal in response to determining that only the touch power signal is received; and output the display power signal in response to determining that only the display power signal is received.

For example, the power switching sub-circuit includes a display driving unit and a touch driving unit; the display driving unit is electrically connected to the display power terminal, the power control sub-circuit and a control signal terminal, and the display driving unit is configured to output the display power signal to the power control sub-circuit under the control of a control signal from the control signal terminal; and the touch driving unit is electrically connected to the touch power terminal, the power control sub-circuit and the control signal terminal, and the touch driving unit is configured to output the touch power signal to the power control sub-circuit under the control of the control signal.

For example, the display driving unit includes a first transistor; and the first transistor has a gate electrode electrically connected to the control signal terminal, a drain electrode electrically connected to the display power terminal, and a source electrode electrically connected to the power control sub-circuit.

For example, the touch driving unit includes a second transistor, a third transistor and a fourth transistor; the second transistor has a gate electrode electrically connected to the control signal terminal, a drain electrode electrically connected to a gate electrode of the fourth transistor, and a source electrode electrically connected to a voltage terminal; the third transistor has a gate electrode electrically connected to the gate electrode of the fourth transistor, a drain electrode electrically connected to the power control sub-circuit, and a source electrode electrically connected to a source electrode of the fourth transistor; and the gate electrode and a drain electrode of the fourth transistor are electrically connected to the touch power terminal.

For example, the touch driving unit is further electrically connected to the display power terminal, and the touch driving unit is configured to output the touch power signal to the power control sub-circuit under the control of the control signal and the display power signal.

For example, the touch driving unit includes a second transistor and a third transistor; the second transistor has a gate electrode electrically connected to the control signal terminal, a drain electrode electrically connected to the display power terminal, and a source electrode electrically connected to a voltage terminal; and the third transistor has a gate electrode electrically connected to the display power terminal, a drain electrode electrically connected to the power control sub-circuit, and a source electrode electrically connected to the touch power terminal.

For example, the touch driving unit includes a second transistor, a third transistor and a fourth transistor; the second transistor has a gate electrode electrically connected to the control signal terminal, a drain electrode electrically connected to the display power terminal, and a source electrode electrically connected to a voltage terminal; the third transistor has a gate electrode electrically connected to the display power terminal, a drain electrode electrically connected to the power control sub-circuit, and a source electrode electrically connected to a source electrode of the fourth transistor; and the fourth transistor has a gate electrode electrically connected to the display power terminal, and a drain electrode electrically connected to the touch power terminal.

For example, the driving circuit further includes: a timing control sub-circuit, electrically connected to the power control sub-circuit and the source driving circuit, where the timing control sub-circuit is configured to output a synchronization signal under the drive of a timing power signal from the power control sub-circuit; and a signal control sub-circuit, electrically connected to the timing control sub-circuit, the source driving circuit and the touch power terminal, where the signal control sub-circuit is configured to receive the touch power signal and output a switching signal based on the synchronization signal under the drive of the touch power signal, and the switching signal is configured to control the source driving circuit to switch between a display driving mode and a touch driving mode; where the power control sub-circuit is further configured to output the timing power signal to the timing control sub-circuit under the drive of the touch power signal or the display power signal.

For example, the signal control sub-circuit is further configured to receive the display power signal and output a control signal based on the display driving signal; and the power switching sub-circuit is further configured to output the touch power signal or the display power signal to the power control sub-circuit based on the control signal.

For example, the timing control sub-circuit is further configured to receive the control signal and output a display signal to the source driving circuit based on the control signal.

For example, the signal control sub-circuit is further configured to receive a sleep signal and output a control signal based on the sleep signal; and the power switching sub-circuit is configured to enter an off state based on the control signal.

For example, the signal control sub-circuit is further configured to receive a sleep signal and output a sleep mode signal based on the sleep signal; and the timing control sub-circuit is configured to output a display signal to the source driving circuit based on the sleep mode signal, the display signal is configured to control the source driving circuit to output a data signal, and the data signal is controlled by the display signal to indicate a grayscale value of 0.

According to a second aspect, the present disclosure provides a display device, including: a mainboard configured to output a display power signal and a touch power signal; the driving circuit provided by the embodiments of the present disclosure, electrically connected to the mainboard, where the driving circuit is configured to output a source power signal based on the display power signal or the touch power signal; a source driving circuit electrically connected to the driving circuit, where the source driving circuit is configured to output a data signal under the control of the source power signal; and a display panel electrically connected to the source driving circuit, where the display panel is configured to display a picture based on the data signal.

For example, the display panel is further configured to generate a sensor signal in response to a touch operation being received; the source driving circuit is further configured to collect the sensor signal and output a touch signal based on the sensor signal; and the driving circuit is further configured to receive and process the touch signal to obtain information related to the touch operation.

According a third aspect, the present disclosure provides a driving method applied to the driving circuit provided by the embodiments of the present disclosure, including: outputting a touch power signal from a touch power terminal or a display power signal from a display power terminal based on a signal output state of the touch power terminal and a signal output state of the display power terminal; and outputting a source power signal to a source driving circuit under the drive of the touch power signal or the display power signal.

For example, the outputting a touch power signal from a touch power terminal or a display power signal from a display power terminal based on a signal output state of the touch power terminal and a signal output state of the display power terminal includes: outputting the display power signal in response to determining that the touch power signal and the display power signal are received; outputting the touch power signal in response to determining that only the touch power signal is received; and outputting the display power signal in response to determining that only the display power signal is received.

For example, the outputting a touch power signal from a touch power terminal or a display power signal from a display power terminal based on a signal output state of the touch power terminal and a signal output state of the display power terminal includes: outputting a control signal based on the signal output state of the touch power terminal and the signal output state of the display power terminal; and outputting the display power signal or the touch power signal under the control of the control signal.

For example, the outputting a control signal based on the signal output state of the touch power terminal and the signal output state of the display power terminal includes: outputting the control signal having a first level in response to determining that the touch power signal and the display power signal are received; outputting the control signal having a second level in response to determining that only the touch power signal is received; and outputting the control signal having the first level in response to determining that only the display power signal is received.

For example, the outputting the display power signal or the touch power signal under the control of the control signal includes: outputting the display power signal in response to determining that the control signal has the first level; and outputting the touch power signal in response to determining that the control signal has the second level.

For example, the driving method further includes: outputting a display signal under the control of the control signal, where the display signal is configured to control the source driving circuit to output a data signal, and the data signal is controlled by the display signal to indicate a grayscale value of 0 when it is determined that the control signal has the second level.

For example, the driving method further includes: outputting a clock control signal under the control of the control signal, where the clock control signal is configured to control an output state of a clock signal, and the clock signal is turned off based on the clock control signal when it is determined that the control signal has the second level.

For example, the driving method further includes: outputting a control signal having a first level based on a received sleep signal, where the sleep signal indicates that the display power terminal outputs no display power signal.

For example, the driving method further includes: outputting a sleep mode signal based on a received sleep signal; and outputting a display signal under the control of the sleep mode signal, where the display signal is configured to control the source driving circuit to output a data signal, and the data signal is controlled by the display signal to indicate a grayscale value of 0 under the control of the sleep mode signal.

For example, the driving method further includes: outputting a timing power signal under the drive of the touch power signal or the display power signal; outputting a synchronization signal under the drive of the timing power signal; and outputting a switching signal based on the synchronization signal, where the switching signal is configured to control the source driving circuit to switch between a display driving mode and a touch driving mode.

### BRIEF DESCRIPTION OF THE DRAWINGS

FIG. 1 shows a schematic structural diagram of a driving circuit according to an embodiment of the present disclosure;

FIG. 2 shows a schematic structural diagram of a driving circuit according to another embodiment of the present disclosure;

FIG. 3 shows a schematic structural diagram of a driving circuit according to another embodiment of the present disclosure;

FIG. 4 shows a schematic structural diagram of a driving circuit according to another embodiment of the present disclosure;

FIG. 5 shows a schematic structural diagram of a driving circuit according to another embodiment of the present disclosure;

FIG. 6A shows a schematic structural diagram of a driving circuit according to another embodiment of the present disclosure;

FIG. 6B shows a schematic layout diagram of the driving circuit shown in FIG. 6A;

FIG. 7 shows a schematic structural diagram of a driving circuit according to another embodiment of the present disclosure;

FIG. 8 shows a schematic structural diagram of a signal control sub-circuit according to an embodiment of the present disclosure;

FIG. 9 shows a schematic structural diagram of a driving circuit according to another embodiment of the present disclosure;

FIG. 10 shows a schematic structural diagram of a display device according to an embodiment of the present disclosure;

FIG. 11 shows a schematic structural diagram of a display device according to another embodiment of the present disclosure; and

FIG. 12 shows a flowchart of a driving method according to an embodiment of the present disclosure.

### DETAILED DESCRIPTION OF EMBODIMENTS

In order to make objectives, technical solutions and advantages of the present disclosure clearer, the technical solutions in the embodiments of present disclosure will be clearly and completely described below with reference to the accompanying drawings in the embodiments of the present disclosure. Obviously, the described embodiments are only a part but not all of the embodiments of the present disclosure. Based on the described embodiments of the present disclosure, all additional embodiments obtained by those ordinary skilled in the art without carrying out inventive effort fall within the protection scope of the present disclosure. It should be noted that throughout the accompanying drawings, the same elements are represented by the same or similar reference numerals. In the following descriptions, some specific embodiments are just used for descriptive purposes and should not be construed as limiting the present disclosure, but rather examples of the embodiments of the present disclosure. When it is possible to cause confusion in the understanding of the present disclosure, conventional structures or configurations will be omitted. It should be noted that the shape and size of each component in the figures do not reflect the actual size and ratio, but just illustrate the contents of the embodiments of the present disclosure.

Unless otherwise defined, the technical or scientific terms used in the embodiments of the present disclosure should have the usual meanings understood by those skilled in the art. The words “first”, “second” and the like used in the embodiments of the present disclosure do not indicate any order, quantity or importance, but are just used to distinguish different composition parts.

In addition, in the description of the embodiments of the present disclosure, the terms “interconnected” or “connected to” may mean that two components are connected directly or two components are connected through one or more other components. In addition, the two components may be connected or coupled in a wired or wireless manner.

In addition, in the description of the embodiments of the present disclosure, the terms “first level” and “second level” are just used to distinguish two levels in terms of amplitude. For example, the “first level” being a relatively low level and the “second level” being a relatively high level are taken as examples below for description. Those skilled in the art may understand that the present disclosure is not limited to this.

It should be noted that in the description of the embodiments of the present disclosure, a symbol GPIO may represent either a control signal terminal or a control signal provided by the control signal terminal, a symbol Touch Power may represent either a touch power signal terminal or a touch power signal provided by the touch power signal terminal or represent a voltage of the touch power signal, a symbol Display Power may represent either a display power signal terminal or a display power signal provided by the display power signal terminal or represent a voltage of the display power signal, a symbol GND may represent either a voltage terminal or a voltage provided by the voltage terminal. The same applies to the following embodiments and will not be repeated.

In an in-cell touch display screen, a source driving circuit is powered by a display power supply. When the display panel is not in operation, the display power supply does not supply power. For example, when no picture is displayed on the display panel, the display power supply may supply no power temporarily. Without receiving a power signal, the source driving circuit may fail to operate normally, and thus the touch panel may also fail to operate normally.

In view of the above problems, the present disclosure provides a driving circuit for driving a source driving circuit, including: a power switching sub-circuit, electrically connected to a touch power terminal and a display power terminal, where the power switching sub-circuit is configured to output a touch power signal from the touch power terminal or a display power signal from the display power terminal based on a signal output state of the touch power terminal and a signal output state of the display power terminal; and a power control sub-circuit electrically connected to the power switching sub-circuit and the source driving circuit, where the power control sub-circuit is configured to output a source power signal to the source driving circuit under the drive of the touch power signal or the display power signal.

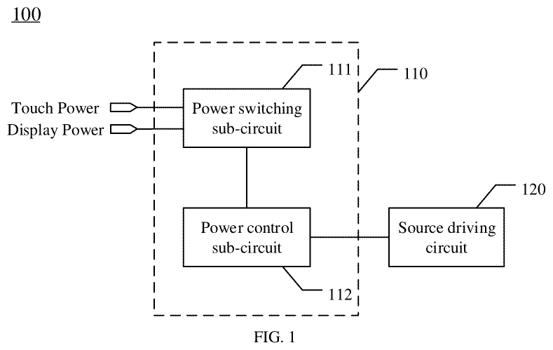

FIG. 1 shows a schematic structural diagram of a driving circuit according to an embodiment of the present disclosure.

As shown in FIG. 1, in embodiment 100, a driving circuit 110 is electrically connected to a source driving circuit 120, and the driving circuit 110 supplies power to the source driving circuit 120 so that the source driving circuit 120 may operate normally.

In embodiments of the present disclosure, the driving circuit 110 includes a power switching sub-circuit 111 and a power control sub-circuit 112.

In embodiments of the present disclosure, the power switching sub-circuit 111 is electrically connected to a touch power terminal Touch Power and a display power terminal Display Power. The touch power terminal Touch Power is used to provide a touch power signal Touch Power. The touch power signal Touch Power may supply power to a touch panel in a touch display screen, so that the touch panel may start normally. The display power terminal Display Power is used to provide a display power signal Display Power. The display power signal Display Power may supply power to a display panel in the touch display screen, so that the display panel may start normally.

The power switching sub-circuit 111 may output the touch power signal Touch Power or the display power signal Display Power based on a signal output state of the touch power terminal Touch Power and a signal output state of the display power terminal Display Power.

For example, the power switching sub-circuit 111 may select a power signal from the touch power signal Touch Power and the display power signal Display Power according to the signal output by the touch power terminal Touch Power and the display power terminal Display Power, and output the selected power signal to the power control sub-circuit 112.

For example, the power switching sub-circuit 111 may output the display power signal Display Power to the power control sub-circuit 112 by default, or switch the output power signal from the display power signal Display Power to the touch power signal Touch Power.

For example, when the touch power terminal Touch Power provides the touch power signal Touch Power, the power switching sub-circuit 111 may receive the touch power signal Touch Power, and it may be considered that the touch power terminal Touch Power is in a power-on state at this time. When the touch power terminal Touch Power provides no touch power signal Touch Power, the power switching sub-circuit 111 receives no touch power signal Touch Power, and it may be considered that the touch power terminal Touch Power is in a power-down state at this time.

Similarly, when the display power terminal Display Power provides the display power signal Display Power, the power switching sub-circuit 111 may receive the display power signal Display Power, and it may be considered that the display power terminal Display Power is in a power-on state at this time. When the display power terminal Display Power provides no display power signal Display Power, the power switching sub-circuit 111 may receive no display power signal Display Power, and it may be considered that the display power terminal Display Power is in a power-down state at this time.

The power switching sub-circuit 111 may select a power signal from the touch power signal Touch Power and the display power signal Display Power according to the power-on state or power-down state of the touch power terminal Touch Power and the display power terminal Display Power, and output the selected power signal to the power control sub-circuit 112.

In embodiments of the present disclosure, the power control sub-circuit 112 is electrically connected to the power switching sub-circuit 111 and the source driving circuit 120. For example, the power control sub-circuit 112 may be a power management integrated circuit (PMIC).

Under the drive of the touch power signal Touch Power or the display power signal Display Power, a source power signal may be output to the source driving circuit 120. The source power signal is a power signal that starts the source driving circuit 120, and the source power signal supplies power to the source driving circuit 120.

For example, if the power switching sub-circuit 111 outputs the touch power signal Touch Power, the power control sub-circuit 112 may convert the touch power signal Touch Power into the source power signal. If the power switching sub-circuit 111 outputs the display power signal Display Power, the power control sub-circuit 112 may convert the display power signal Display Power into the source power signal.

In embodiments of the present disclosure, the source driving circuit 120 may participate in the operation of the display panel. For example, the source driving circuit 120 may output a data signal to the display panel, so that the display panel may display data. The source driving circuit 120 may further participate in the operation of the touch panel. For example, the source driving circuit 120 may receive a sensor signal from the touch panel to determine a touch operation received by the touch panel. Therefore, when the source driving circuit 120 is in an unpowered state, the source driving circuit 120 may fail to operate normally, resulting in that the display panel and the touch panel both fail to operate normally.

In embodiments of the present disclosure, when the display power terminal Display Power supplies power, the power switching sub-circuit 111 may output the display power signal Display Power to the power control sub-circuit 112. When the display power terminal Display Power powers down, the power switching sub-circuit 111 may switch to output the touch power signal Touch Power to the power control sub-circuit 112. In this way, the power control sub-circuit 112 may be in a powered state all the time, and it is thus ensured that the source driving circuit 120 may also be in a powered state all the time.

In embodiments of the present disclosure, if it is determined that the touch power signal Touch Power and the display power signal Display Power are received, the power switching sub-circuit 111 may output the display power signal Display Power. If it is determined that only the touch power signal Touch Power is received, the power switching sub-circuit 111 may output the touch power signal Touch Power. If it is determined that only the display power signal Display Power is received, the power switching sub-circuit 111 may output the display power signal Display Power.

For example, when the touch power terminal Touch Power and the display power terminal Display Power are both in the power-on state, the power switching sub-circuit 111 may receive the touch power signal Touch Power and the display power signal Display Power. In this case, the power switching sub-circuit 111 may output the display power signal Display Power to the power control sub-circuit 112.

For example, when the touch power terminal Touch Power is in the power-on state and the display power terminal Display Power is in the power-down state, the power switching sub-circuit 111 may receive only the touch power signal Touch Power. In this case, the power switching sub-circuit 111 may output the touch power signal Touch Power to the power control sub-circuit 112.

For example, when the touch power terminal Touch Power is in the power-down state and the display power terminal Display Power is in the power-on state, the power switching sub-circuit 111 may receive only the display power signal Display Power. In this case, the power switching sub-circuit 111 may output the display power signal Display Power to the power control sub-circuit 112.

For example, the power control sub-circuit 112 is powered by the display power signal Display Power by default. When the display panel displays no picture, the display power terminal Display Power may be in a power-down state. Therefore, in the driving circuit 110 provided in embodiments of the present disclosure, through the design of the power switching sub-circuit 111, the touch power terminal Touch Power and the display power terminal Display Power are both connected to the power switching sub-circuit 111. In a case of no power supply or an unexpected power failure of the display power terminal Display Power, the touch power terminal Touch Power may supply power to ensure the normal operation of the power control sub-circuit 112 and the source driving circuit 120, and thus ensure a normal touch function of the touch panel.

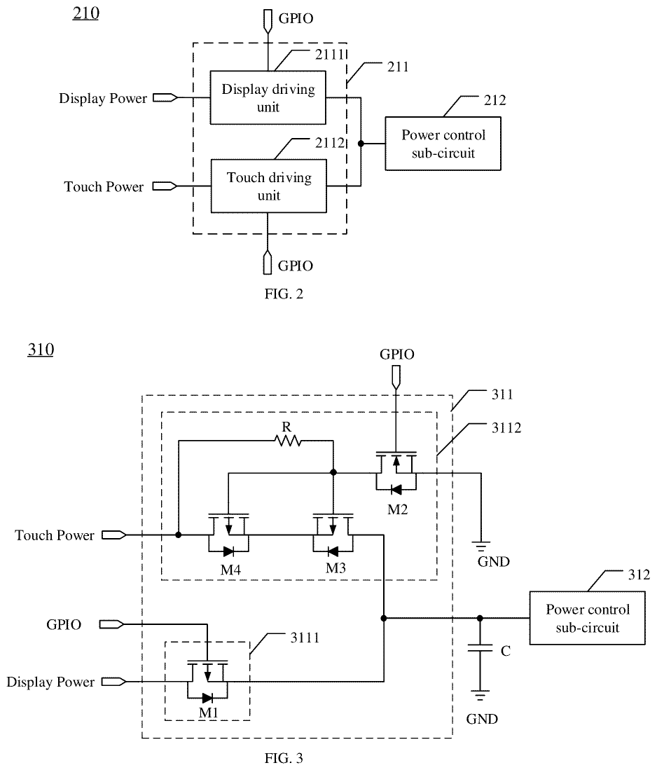

FIG. 2 shows a schematic structural diagram of a driving circuit according to another embodiment of the present disclosure.

As shown in FIG. 2, the driving circuit 210 includes a power switching sub-circuit 211 and a power control sub-circuit 212.

In embodiments of the present disclosure, the power switching sub-circuit 211 and the power control sub-circuit 212 are respectively similar to the power switching sub-circuit 111 and the power control sub-circuit 112 mentioned above. For the sake of conciseness, the same part will not be repeated in the present disclosure.

In embodiments of the present disclosure, the power switching sub-circuit 211 includes a display driving unit 2111 and a touch driving unit 2112.

In embodiments of the present disclosure, the display driving unit 2111 is electrically connected to the display power terminal Display Power, the power control sub-circuit 212 and a control signal terminal GPIO. Under the control of a control signal GPIO from the control signal terminal GPIO, the display driving unit 2111 may output the display power signal Display Power to the power control sub-circuit 212.

For example, the display power terminal Display Power may provide the display power signal Display Power to the display driving unit 2111. The control signal GPIO may control the display driving unit 2111 to be in an on state or an off state. When the control signal GPIO controls the display driving unit 2111 to be in the on state, the display driving unit 2111 may output the display power signal Display Power to the power control sub-circuit 212.

In embodiments of the present disclosure, the touch driving unit 2112 is electrically connected to the touch power terminal Touch Power, the power control sub-circuit 212 and the control signal terminal GPIO. Under the control of the control signal GPIO from the control signal terminal GPIO, the touch driving unit 2112 may output the touch power signal Touch Power to the power control sub-circuit 212.

For example, the touch power terminal Touch Power may provide the touch power signal Touch Power to the touch driving unit 2112. The control signal GPIO may control the touch driving unit 2112 to be in the on state or the off state. When the control signal GPIO controls the touch driving unit 2112 to be in the on state, the touch driving unit 2112 may output the touch power signal Touch Power to the power control sub-circuit 212.

In embodiments of the present disclosure, when the touch power terminal Touch Power and the display power terminal Display Power are both in the power-on state, the touch driving unit 2112 may receive the touch power signal Touch Power, and the display driving unit 2111 may receive the display power signal Display Power. Then, the control signal GPIO may control the display driving unit 2111 to be in the on state, and control the touch driving unit 2112 to be in the off state. In this case, the display driving unit 2111 may output the display power signal Display Power to the power control sub-circuit 212.

In embodiments of the present disclosure, when the touch power terminal Touch Power is in the power-on state and the display power terminal Display Power is in the power-down state, only the touch driving unit 2112 may receive the touch power signal Touch Power, and the display driving unit 2111 receives no display power signal Display Power. Then, the control signal GPIO may control the display driving unit 2111 to be in the off state, and control the touch driving unit 2112 to be in the on state. In this case, the touch driving unit 2112 may output the touch power signal Touch Power to the power control sub-circuit 212.

In embodiments of the present disclosure, when the touch power terminal Touch Power is in the power-off state and the display power terminal Display Power is in the power-on state, only the display driving unit 2111 may receive the display power signal Display Power, and the touch driving unit 2112 receives no touch power signal Touch Power. Then, the control signal GPIO may control the display driving unit 2111 to be in the on state, and control the touch driving unit 2112 to be in the off state. In this case, the display driving unit 2111 may output the display power signal Display Power to the power control sub-circuit 212.

FIG. 3 shows a schematic structural diagram of a driving circuit according to another embodiment of the present disclosure.

As shown in FIG. 3, the driving circuit 310 includes a power switching sub-circuit 311 and a power control sub-circuit 312. The power switching sub-circuit 311 includes a display driving unit 3111 and a touch driving unit 3112.

In embodiments of the present disclosure, the power switching sub-circuit 311 and the power control sub-circuit 312 are respectively similar to the power switching sub-circuit 111 and the power control sub-circuit 112 mentioned above, and the display driving unit 3111 and the touch driving unit 3112 are respectively similar to the display driving unit 2111 and the touch driving unit 2112 mentioned above. For the sake of conciseness, the same part will not be repeated in the present disclosure.

In embodiments of the present disclosure, the display driving unit 3111 includes a first transistor M1. The first transistor M1 is a PMOS transistor.

In embodiments of the present disclosure, the first transistor M1 has a gate electrode electrically connected to the control signal terminal GPIO, a drain electrode electrically connected to the display power terminal Display Power, and a source electrode electrically connected to the power control sub-circuit 312.

In embodiments of the present disclosure, the touch driving unit 3112 includes a second transistor M2, a third transistor M3 and a fourth transistor M4. The second transistor M2 is an NMOS transistor, and the third transistor M3 and the fourth transistor M4 are PMOS transistors.

In embodiments of the present disclosure, the second transistor M2 has a gate electrode electrically connected to the control signal terminal GPIO, a drain electrode electrically connected to a gate electrode of the fourth transistor M4, and a source electrode electrically connected to a voltage terminal GND. The third transistor M3 has a gate electrode electrically connected to the gate electrode of the fourth transistor M4, a drain electrode electrically connected to the power control sub-circuit 312, and a source electrode electrically connected to a source electrode of the fourth transistor M4. The gate electrode and a drain electrode of the fourth transistor M4 are both electrically connected to the touch power terminal Touch Power.

In embodiments of the present disclosure, the touch driving unit 3112 further includes a resistor R. For example, the resistor R may have a resistance of 100 KΩ. The resistor R has a first end electrically connected to the touch power terminal Touch Power and a second end electrically connected to the gate electrode of the third transistor M3. The touch power signal Touch Power may be applied to the gate electrode of the third transistor M3 through the resistor R. The voltage terminal GND may be a ground terminal, and a voltage of the voltage terminal GND may be 0 V. The resistor R may divide a voltage of the touch power signal Touch Power provided by the touch power terminal Touch Power, so as to avoid a short circuit when the second transistor M2 is turned on.

In embodiments of the present disclosure, the driving circuit 310 further includes a capacitor C. The capacitor C has a first end electrically connected to the power control sub-circuit 312 and a second end electrically connected to the voltage terminal GND. The capacitor C may function to stabilize the voltage of the power signal input to the power control sub-circuit 312.

In embodiments of the present disclosure, a voltage of the control signal GPIO provided by the control signal terminal GPIO is related to a power supply state of the display power terminal Display Power.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in an on state and the second transistor M2 is in an off state. When the touch power terminal Touch Power is in the power-on state, the touch power signal Touch Power is applied to the gate electrode of the third transistor M3, the gate electrode of the fourth transistor M4 and the drain electrode of the fourth transistor M4. A gate voltage of the third transistor M3 and a gate voltage of the fourth transistor M4 may gradually increase. As the third transistor M3 and the fourth transistor M4 are PMOS transistors, the third transistor M3 and the fourth transistor M4 may be in the off state.

In this case, the second transistor M2, the third transistor M3 and the fourth transistor in the touch driving unit 3112 are all in the off state, and the first transistor M1 in the display driving unit 3111 is in the on state. Accordingly, when the display power terminal Display Power and the touch power terminal Touch Power are both in the power-on state, the display power signal Display Power may be output to the power control sub-circuit 312 through the first transistor M1.

In embodiments of the present disclosure, when the display power terminal Display Power is in the power-off state, the control signal GPIO is at a high level. The first transistor M1 is a PMOS transistor and the second transistor M2 is an NMOS transistor. Under the control of the high level of the control signal GPIO, the first transistor M1 is in the off state and the second transistor M2 is in the on state. When the second transistor M2 is in the on state, due to the action of the resistor R, the voltage GND is applied to the gate electrode of the third transistor M3 and the gate electrode of the fourth transistor M4 through the second transistor M2. As the third transistor M3 and the fourth transistor M4 are PMOS transistors, the third transistor M3 and the fourth transistor M4 may be in the on state under the control of the voltage GND having a low level.

In this case, the second transistor M2, the third transistor M3 and the fourth transistor in the touch driving unit 3112 are all in the on state, and the first transistor M1 in the display driving unit 3111 is in the off state. Accordingly, when the display power terminal Display Power is in the power-down state and the touch power terminal Touch Power is in the power-on state, the touch power signal Touch Power may be output to the power control sub-circuit 312 through the third transistor M3 and the fourth transistor M4.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in the on state and the second transistor M2 is in the off state. When the touch power terminal Touch Power is in the power-down state, the third transistor M3 and the fourth transistor M4 are in the off state.

In this case, the second transistor M2, the third transistor M3 and the fourth transistor in the touch driving unit 3112 are all in the off state, and the first transistor M1 in the display driving unit 3111 is in the on state. Accordingly, when the display power terminal Display Power is in the power-on state and the touch power terminal Touch Power is in the power-down state, the display power signal Display Power may be output to the power control sub-circuit 312 through the first transistor M1.

Through embodiments of the present disclosure, when the display power terminal Display Power supplies power, the first transistor M1 is in the on state, the second transistor M2, the third transistor M3 and the fourth transistor are all in the off state, and the display power signal Display Power is output to the power control sub-circuit 312 through the first transistor M1. When the display power terminal Display Power is in the power-down state, the first transistor M1 is in the off state, the second transistor M2, the third transistor M3 and the fourth transistor are all in the on state, and the touch power terminal Touch Power may output the touch power signal Touch Power to the power control sub-circuit 312 through the third transistor M3 and the fourth transistor. Therefore, a switching and an output of the power signal may be achieved through a connection structure of the transistors in the power switching sub-circuit 311. In addition, the transistors have advantages of easy control, small voltage drop and fast response speed. Through the power switching sub-circuit 311 mentioned above, it is possible to reduce a voltage drop of the power signal output to the power control sub-circuit 312, thereby stabilizing the voltage of the power signal output to the power control sub-circuit 312.

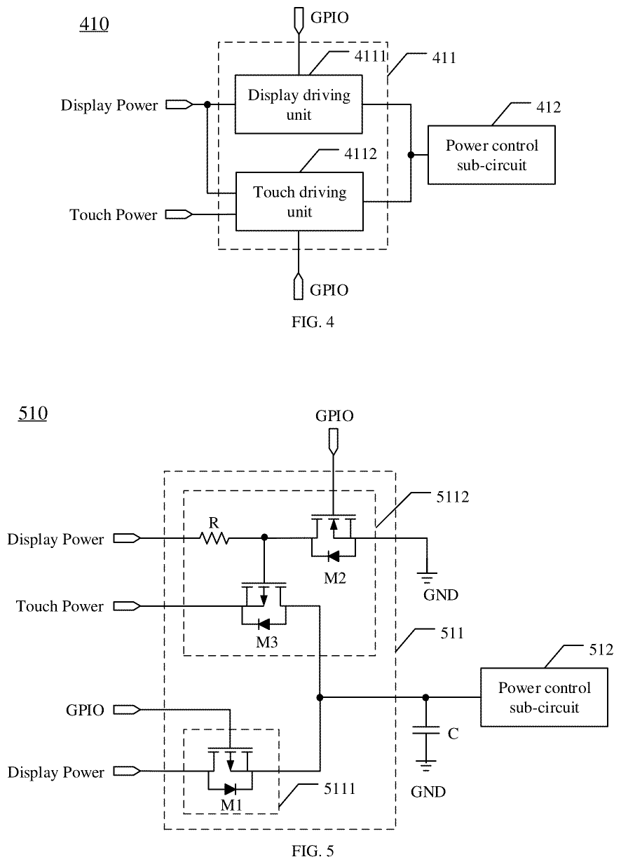

FIG. 4 shows a schematic structural diagram of a driving circuit according to another embodiment of the present disclosure.

As shown in FIG. 4, a driving circuit 410 includes a power switching sub-circuit 411 and a power control sub-circuit 412. The power switching sub-circuit 411 includes a display driving unit 4111 and a touch driving unit 4112.

In embodiments of the present disclosure, the power switching sub-circuit 411 and the power control sub-circuit 412 are respectively similar to the power switching sub-circuit 111 and the power control sub-circuit 112 mentioned above, and the display driving unit 4111 and the touch driving unit 4112 are respectively similar to the display driving unit 2111 and the touch driving unit 2112 mentioned above. For the sake of conciseness, the same part will not be repeated in the present disclosure.

In embodiments of the present disclosure, the touch driving unit 4112 is electrically connected to the display power terminal Display Power, the touch power terminal Touch Power, the power control sub-circuit 412 and the control signal terminal GPIO. Under the control of the control signal GPIO, the touch power signal Touch Power and the display power signal Display Power, the touch driving unit 4112 may output the touch power signal Touch Power to the power control sub-circuit 412.

For example, the touch power terminal Touch Power may provide the touch power signal Touch Power to the touch driving unit 4112. The control signal GPIO and the display power signal Display Power may control the touch driving unit 4112 to be in the on state or the off state. When the control signal GPIO and the display power signal Display Power control the touch driving unit 4112 to be in the on state, the touch driving unit 4112 may output the touch power signal Touch Power to the power control sub-circuit 412.

In embodiments of the present disclosure, when the touch power terminal Touch Power and the display power terminal Display Power are both in the power-on state, the touch driving unit 4112 may receive the touch power signal Touch Power, and the display driving unit 4111 may receive the display power signal Display Power. Then, the control signal GPIO may control the display driving unit 4111 to be in the on state, and the control signal GPIO and the display power signal Display Power may control the touch driving unit 4112 to be in the off state. In this case, the display driving unit 4111 may output the display power signal Display Power to the power control sub-circuit 412.

In embodiments of the present disclosure, when the touch power terminal Touch Power is in the power-on state and the display power terminal Display Power is in the power-down state, only the touch driving unit 4112 may receive the touch power signal Touch Power, and the display driving unit 4111 may receive no display power signal Display Power. Then, the control signal GPIO may control the display driving unit 4111 to be in the off state, and the control signal GPIO and the display power signal Display Power may control the touch driving unit 4112 to be in the on state. In this case, the touch driving unit 4112 may output the touch power signal Touch Power to the power control sub-circuit 412.

In embodiments of the present disclosure, when the touch power terminal Touch Power is in the power-down state and the display power terminal Display Power is in the power-on state, only the display driving unit 4111 may receive the display power signal Display Power, and the touch driving unit 4112 may receive no touch power signal Touch Power. Then, the control signal GPIO may control the display driving unit 4111 to be in the on state, and the control signal GPIO and the display power signal Display Power may control the touch driving unit 4112 to be in the off state. In this case, the display driving unit 4111 may output the display power signal Display Power to the power control sub-circuit 412.

FIG. 5 shows a schematic structural diagram of a driving circuit according to another embodiment of the present disclosure.

As shown in FIG. 5, a driving circuit 510 includes a power switching sub-circuit 511 and a power control sub-circuit 512. The power switching sub-circuit 511 includes a display driving unit 5111 and a touch driving unit 5112.

In embodiments of the present disclosure, the power switching sub-circuit 511 and the power control sub-circuit 512 are respectively similar to the power switching sub-circuit 111 and the power control sub-circuit 112 mentioned above, and the display driving unit 5111 and the touch driving unit 5112 are respectively similar to the display driving unit 2111 and the touch driving unit 2112 mentioned above. For the sake of conciseness, the same part will not be repeated in the present disclosure.

In embodiments of the present disclosure, the display driving unit 5111 includes a first transistor M1. The first transistor M1 is a PMOS transistor.

In embodiments of the present disclosure, the first transistor M1 has a gate electrode electrically connected to the control signal terminal GPIO, a drain electrode electrically connected to the display power terminal Display Power, and a source electrode electrically connected to the power control sub-circuit 512.

In embodiments of the present disclosure, the touch driving unit 5112 includes a second transistor M2 and a third transistor M3. The second transistor M2 is an NMOS transistor, and the third transistor M3 is a PMOS transistor.

In embodiments of the present disclosure, the second transistor M2 has a gate electrode electrically connected to the control signal terminal GPIO, a drain electrode electrically connected to the display power terminal Display Power, and a source electrode electrically connected to the voltage terminal GND. The third transistor M3 has a gate electrode electrically connected to the display power terminal Display Power, a drain electrode electrically connected to the power control sub-circuit 512, and a source electrode electrically connected to the touch power terminal Touch Power.

In embodiments of the present disclosure, the touch driving unit 5112 further includes a resistor R. The resistor R has a first end electrically connected to the display power terminal Display Power and a second end electrically connected to the gate electrode of the third transistor M3. The display power terminal Display Power may be applied to the gate electrode of the third transistor M3 through the resistor R. The voltage terminal GND may be a ground terminal, and a voltage of the voltage terminal GND may be 0 V. The resistor R may divide a voltage of the touch power signal Touch Power provided by the touch power terminal Touch Power, so as to avoid a short circuit when the second transistor M2 is turned on.

In embodiments of the present disclosure, the driving circuit 510 further includes a capacitor C. The capacitor C has a first end electrically connected to the power control sub-circuit 512 and a second end electrically connected to the voltage terminal GND. The capacitor C may function to stabilize the voltage of the power signal input to the power control sub-circuit 512.

In embodiments of the present disclosure, a voltage of the control signal GPIO provided by the control signal terminal GPIO is related to the power supply state of the display power terminal Display Power.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in the on state and the second transistor M2 is in the off state. The display power signal Display Power is further applied to the gate electrode of the third transistor M3, and the gate electrode of the third transistor M3 may gradually increase. As the third transistor M3 is a PMOS transistor, the third transistor M3 is in the off state.

In this case, the second transistor M2 and the third transistor M3 in the touch driving unit 5112 are both in the off state, and the first transistor M1 in the display driving unit 5111 is in the on state. Accordingly, when the display power terminal Display Power and the touch power terminal Touch Power are both in the power-on state, the display power signal Display Power may be output to the power control sub-circuit 512 through the first transistor M1.

In embodiments of the present disclosure, when the display power terminal Display Power is in the power-off state, the control signal GPIO is at a high level. The first transistor M1 is a PMOS transistor and the second transistor M2 is an NMOS transistor. Under the control of the high level of the control signal GPIO, the first transistor M1 is in the off state and the second transistor M2 is in the on state. When the second transistor M2 is in the on state, due to the action of the resistor R, the voltage GND is applied to the gate electrode of the third transistor M3 through the second transistor M2. As the third transistor M3 is a PMOS transistor, the third transistor M3 may be in the on state under the control of the voltage GND having a low level.

In this case, the second transistor M2 and the third transistor M3 in the touch driving unit 5112 are both in the on state, and the first transistor M1 in the display driving unit 5111 is in the off state. Accordingly, when the display power terminal Display Power is in the power-down state and the touch power terminal Touch Power is in the power-on state, the touch power signal Touch Power may be output to the power control sub-circuit 512 through the third transistor M3.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in the on state and the second transistor M2 is in the off state. The display power signal Display Power is further applied to the gate electrode of the third transistor M3, and the gate electrode of the third transistor M3 may gradually increase. As the third transistor M3 is a PMOS transistor, the third transistor M3 is in the off state.

In this case, the second transistor M2 and the third transistor M3 in the touch driving unit 5112 are both in the off state, and the first transistor M1 in the display driving unit 5111 is in the on state. Accordingly, when the display power terminal Display Power is in the power-on state and the touch power terminal Touch Power is in the power-down state, the display power signal Display Power may be output to the power control sub-circuit 512 through the first transistor M1.

Through embodiments of the present disclosure, when the display power terminal Display Power supplies power, the first transistor M1 is in the on state, the second transistor M2 and the third transistor M3 are both in the off state, and the display power signal Display Power is output to the power control sub-circuit 512 through the first transistor M1. When the display power terminal Display Power is in the power-down state, the first transistor M1 is in the off state, the second transistor M2 and the third transistor M3 are both in the on state, and the touch power terminal Touch Power may output the touch power signal Touch Power to the power control sub-circuit 512 through the third transistor M3. Therefore, a switching and an output of the power signal may be achieved through a connection structure of the transistors in the power switching sub-circuit 511. In addition, the transistors have advantages of easy control, small voltage drop and fast response speed. Through the power switching sub-circuit 511 mentioned above, it is possible to reduce a voltage drop of the power signal output to the power control sub-circuit 512, thereby stabilizing the voltage of the power signal output to the power control sub-circuit 512.

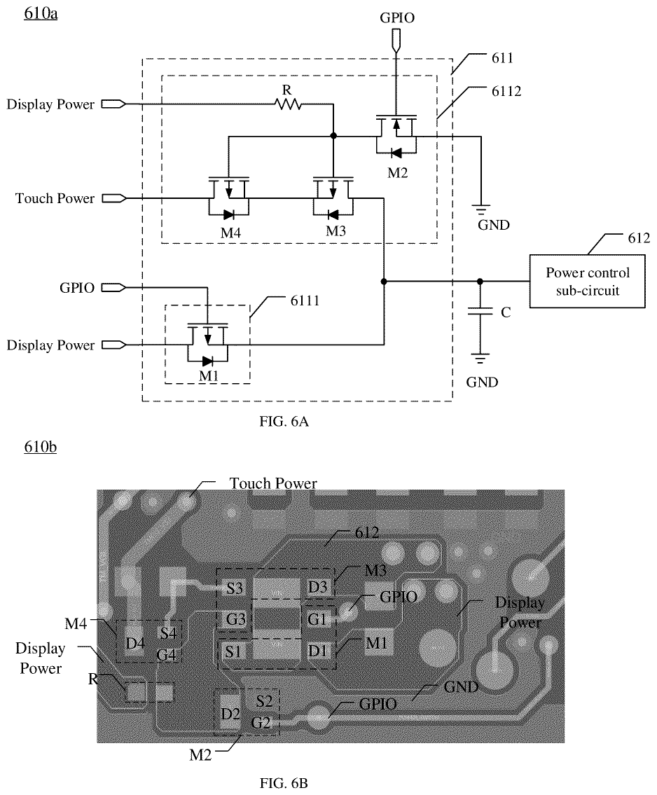

FIG. 6A shows a schematic structural diagram of a driving circuit according to another embodiment of the present disclosure.

As shown in FIG. 6A, a driving circuit 610a includes a power switching sub-circuit 611 and a power control sub-circuit 612. The power switching sub-circuit 611 includes a display driving unit 6111 and a touch driving unit 6112.

In embodiments of the present disclosure, the power switching sub-circuit 611 and the power control sub-circuit 612 are respectively similar to the power switching sub-circuit 111 and the power control sub-circuit 112 mentioned above, and the display driving unit 6111 and the touch driving unit 6112 are respectively similar to the display driving unit 2111 and the touch driving unit 2112 mentioned above. For the sake of conciseness, the same part will not be repeated in the present disclosure.

In embodiments of the present disclosure, the display driving unit 6111 includes a first transistor M1. The first transistor M1 is a PMOS transistor.

In embodiments of the present disclosure, the first transistor M1 has a gate electrode electrically connected to the control signal terminal GPIO, a drain electrode electrically connected to the display power terminal Display Power, and a source electrode electrically connected to the power control sub-circuit 612.

In embodiments of the present disclosure, the touch driving unit 6112 includes a second transistor M2, a third transistor M3 and a fourth transistor M4. The second transistor M2 is an NMOS transistor, and the fourth transistor M4 and the third transistor M3 are PMOS transistors.

In embodiments of the present disclosure, the second transistor M2 has a gate electrode electrically connected to the control signal terminal GPIO, a drain electrode electrically connected to the display power terminal Display Power, and a source electrode electrically connected to the voltage terminal GND. The third transistor M3 has a gate electrode electrically connected to the display power terminal Display Power, a drain electrode electrically connected to the power control sub-circuit 612, and a source electrode electrically connected to a source electrode of the fourth transistor M4. The fourth transistor M4 has a gate electrode electrically connected to the display power terminal Display Power and a drain electrode electrically connected to the touch power terminal Touch Power.

In embodiments of the present disclosure, the touch driving unit 6112 further includes a resistor R. The resistor R has a first end electrically connected to the display power terminal Display Power and a second end electrically connected to the gate electrode of the third transistor M3. The display power terminal Display Power may be applied to the gate electrode of the third transistor M3 through the resistor R. The voltage terminal GND may be a ground terminal, and a voltage of the voltage terminal GND may be 0 V. The resistor R may divide a voltage of the touch power signal Touch Power provided by the touch power terminal Touch Power, so as to avoid a short circuit when the second transistor M2 is turned on.

In embodiments of the present disclosure, the driving circuit 610 further includes a capacitor C. The capacitor C has a first end electrically connected to the power control sub-circuit 612 and a second end electrically connected to the voltage terminal GND. The capacitor C may function to stabilize the voltage of the power signal input to the power control sub-circuit 612.

In embodiments of the present disclosure, a voltage of the control signal GPIO provided by the control signal terminal GPIO is related to the power supply state of the display power terminal Display Power.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in an on state and the second transistor M2 is in an off state. The display power signal Display Power is further applied to the gate electrode of the third transistor M3, the gate electrode of the fourth transistor M4 and the drain electrode of the second transistor M2 through the resistor R, and a gate voltage of the third transistor M3 and a gate voltage of the fourth transistor M4 may gradually increase. As the third transistor M3 is a PMOS transistor, the third transistor M3 and the fourth transistor M4 are in the off state.

In this case, the second transistor M2, the third transistor M3 and the fourth transistor M4 in the touch driving unit 6112 are all in the off state, and the first transistor M1 in the display driving unit 6111 is in the on state. Accordingly, when the display power terminal Display Power and the touch power terminal Touch Power are both in the power-on state, the display power signal Display Power may be output to the power control sub-circuit 612 through the first transistor M1.

In embodiments of the present disclosure, when the display power terminal Display Power is in the power-off state, the control signal GPIO is at a high level. The first transistor M1 is a PMOS transistor and the second transistor M2 is an NMOS transistor. Under the control of the high level of the control signal GPIO, the first transistor M1 is in the off state and the second transistor M2 is in the on state. When the second transistor M2 is in the on state, due to the action of the resistor R, the voltage GND is applied to the gate electrode of the third transistor M3 and the gate electrode of the fourth transistor M4 through the second transistor M2. As the third transistor M3 and the fourth transistor M4 are PMOS transistors, the third transistor M3 and the fourth transistor M4 may be in the on state under the control of the voltage GND having a low level.

In this case, the second transistor M2, the third transistor M3 and the fourth transistor M4 in the touch driving unit 6112 are all in the on state, and the first transistor M1 in the display driving unit 6111 is in the off state. Accordingly, when the display power terminal Display Power is in the power-down state and the touch power terminal Touch Power is in the power-on state, the touch power signal Touch Power may be output to the power control sub-circuit 612 through the third transistor M3 and the fourth transistor M4.

In embodiments of the present disclosure, when the display power terminal Display Power is in the power-on state, the control signal GPIO is at a low level. The first transistor M1 is a PMOS transistor and the second transistor M2 is an NMOS transistor. Under the control of the low level of the control signal GPIO, the first transistor M1 is in the on state and the second transistor M2 is in the off state. The display power signal Display Power is further applied to the gate electrode of the third transistor M3 and the gate electrode of the fourth transistor M4 through the resistor R, and a gate voltage of the third transistor M3 and a gate voltage of the fourth transistor M4 may gradually increase. As the third transistor M3 and the fourth transistor M4 are PMOS transistors, the third transistor M3 and the fourth transistor M4 may be in the off state.

In this case, the second transistor M2, the third transistor M3 and the fourth transistor M4 in the touch driving unit 6112 are all in the off state, and the first transistor M1 in the display driving unit 6111 is in the on state. Accordingly, when the display power terminal Display Power is in the power-on state and the touch power terminal Touch Power is in the power-down state, the display power signal Display Power may be output to the power control sub-circuit 612 through the first transistor M1.

When the touch power terminal Touch Power is in the power-down state, the touch panel may be in a turn-off state (not in operation). When the display power signal Display Power is output to the power control sub-circuit 612 through the first transistor M1, the display power signal Display Power may be further applied to the source electrode of the fourth transistor M4 through a parasitic diode of the third transistor M3. In this case, the display power signal Display Power may be cut off by a parasitic diode of the fourth transistor M4, so that the display power signal Display Power may not leak to the touch power terminal Touch Power through the third transistor M3 and the fourth transistor M4, thus avoiding a phenomenon of a voltage rise of the touch power terminal Touch Power caused by leakage, which may prevent mistake start-up of the touch panel.

Through embodiments of the present disclosure, when the display power terminal Display Power supplies power, the first transistor M1 is in the on state, the second transistor M2, the third transistor M3 and the fourth transistor M4 are all in the off state, and the display power signal Display Power may be output to the power control sub-circuit 612 through the first transistor M1. When the display power terminal Display Power is in the power-down state, the first transistor M1 is in the off state, the second transistor M2, the third transistor M3 and the fourth transistor M4 are all in the on state, and the touch power terminal Touch Power may output the touch power signal Touch Power to the power control sub-circuit 612 through the third transistor M3 and the fourth transistor. Therefore, a switching and an output of the power signal may be achieved through a connection structure of the transistors in the power switching sub-circuit 511. In addition, the transistors have advantages of easy control, small voltage drop and fast response speed. Through the power switching sub-circuit 611 mentioned above, it is possible to reduce a voltage drop of the power signal output to the power control sub-circuit 612, thereby stabilizing the voltage of the power signal output to the power control sub-circuit 612.

In addition, the source electrode of the third transistor M3 is electrically connected to the source electrode of the fourth transistor M4, and the third transistor M3 and the fourth transistor M4 form an inverter, which may avoid a current leakage in the third transistor M3 and the fourth transistor M4 when the display power terminal Display Power is in the power-on state and the touch power terminal Touch Power is in the power-down state. The drain electrode of the first transistor M1 is electrically connected to the display power terminal Display Power, which may avoid a current leakage in the first transistor M1 when the display power terminal Display Power is in the power-down state and the touch power terminal Touch Power is in the power-on state.

FIG. 6B shows a schematic layout diagram of the driving circuit shown in FIG. 6A.

As shown in FIG. 6B, the first transistor M1 has a gate electrode G1 electrically connected to the control signal terminal GPIO, a drain electrode D1 electrically connected to the display power terminal Display Power, and a source electrode S1 electrically connected to the power control sub-circuit 612.

The second transistor M2 has a gate electrode G2 electrically connected to the control signal terminal GPIO, a drain electrode D2 electrically connected to the display power terminal Display Power, and a source electrode S2 electrically connected to the voltage terminal GND.

The third transistor M3 has a gate electrode G3 electrically connected to the display power terminal Display Power, a drain electrode D3 electrically connected to the power control sub-circuit 612, and a source electrode S3 electrically connected to a source electrode S4 of the fourth transistor M4.

The fourth transistor M4 has a gate electrode electrically connected to the display power terminal Display Power and a drain electrode D4 electrically connected to the touch power terminal Touch Power.

The resistor R has a first end electrically connected to the display power terminal Display Power and a second end electrically connected to the gate electrode G3 of the third transistor M3.

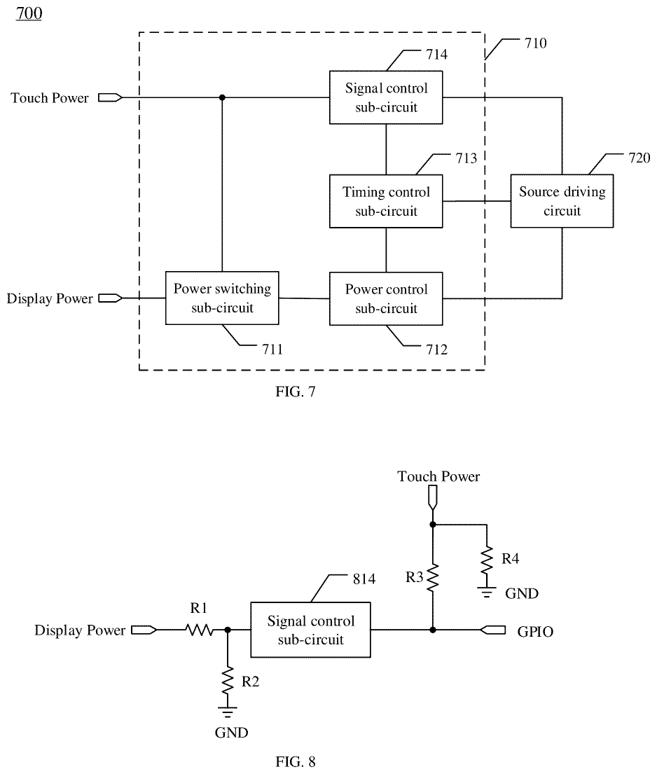

FIG. 7 shows a schematic structural diagram of a driving circuit according to another embodiment of the present disclosure.

As shown in FIG. 7, in embodiment 700, a driving circuit 710 is electrically connected to a source driving circuit 720, and the driving circuit 710 supplies power to the source driving circuit 720, so that the source driving circuit 720 may operate normally.

In embodiments of the present disclosure, the driving circuit 710 includes a power switching sub-circuit 711, a power control sub-circuit 712, a timing control sub-circuit 713, and a signal control sub-circuit 714. The power switching sub-circuit 711 and the power control sub-circuit 712 are similar to the power switching sub-circuit 111 and the power control sub-circuit 112 mentioned above, which will not be repeated here for the sake of conciseness.

In embodiments of the present disclosure, the timing control sub-circuit 713 is electrically connected to the power control sub-circuit 712 and the source driving circuit 720. For example, the timing control sub-circuit 713 may be a time controller (TCON).

The power control sub-circuit 712 may output a timing power signal to the timing control sub-circuit 713 under the drive of the touch power signal Touch Power or the display power signal Display Power. A synchronization signal SYNC may be output under the drive of the timing power signal from the power control sub-circuit 712.

In embodiments of the present disclosure, the signal control sub-circuit 714 is electrically connected to the timing control sub-circuit 713, the source driving circuit 720 and the touch power terminal Touch Power. For example, the signal control sub-circuit 714 may be a micro controller unit (MCU).

The signal control sub-circuit 714 may receive the touch power signal, and output a switching signal based on the synchronization signal SYNC under the drive of the touch power signal. The switching signal is used to control the source driving circuit 720 to switch between a display driving mode and a touch driving mode.

In embodiments of the present disclosure, in the display driving mode, the source driving circuit 720 may provide a data signal to the display panel. In the touch driving mode, the source driving circuit 720 may collect a touch operation from the touch panel. For example, the synchronization signal SYNC may be a pulse signal. When the synchronization signal SYNC is at a high level, the switching signal output by the signal control sub-circuit 714 may control the source driving circuit 720 to enter the display driving mode. When the synchronization signal SYNC is at a low level, the switching signal output by the signal control sub-circuit 714 may control the source driving circuit 720 to enter the touch driving mode.

In embodiments of the present disclosure, the power switching sub-circuit 711 may output the touch power signal Touch Power or the display power signal Display Power to the power control sub-circuit 712. The power control sub-circuit 712 may convert the received power signal into a timing power signal required for an operation of the timing control sub-circuit 713 and a source power signal required for an operation of the source driving circuit 720. The touch power terminal Touch Power may directly output the touch power signal Touch Power to the signal control sub-circuit 714 for an operation of the signal control sub-circuit 714.

In embodiments of the present disclosure, the timing control sub-circuit 713 may further output a display signal to the source driving circuit 720. The source driving circuit 720 may generate a data signal based on the display signal, and the display panel may display a picture based on the data signal.

In embodiments of the present disclosure, the source driving circuit 720 may collect a sensor signal from the touch panel in the touch driving mode. The sensor signal is a signal generated by the touch panel based on a received touch operation. The source driving circuit 720 may generate a touch signal based on the sensor signal and send the touch signal to the signal control sub-circuit 714. The signal control sub-circuit 714 may process the touch signal and send a data processing result to the system, so as to complete a touch report action.

FIG. 8 shows a schematic structural diagram of a signal control sub-circuit according to an embodiment of the present disclosure.

As shown in FIG. 8, a signal control sub-circuit 814 may provide a control signal GPIO output by a control signal terminal GPIO.

In embodiments of the present disclosure, a first end of the signal control sub-circuit 814 is electrically connected to a first end of a first resistor R1 and a first end of a second resistor R2, a second end of the first resistor R1 is electrically connected to the display power terminal Display Power, and a second end of the second resistor R2 is electrically connected to the voltage terminal GND.

A second end of the signal control sub-circuit 814 is electrically connected to a first end of a third resistor R3 and the control signal terminal GPIO, and a second end of the third resistor R3 is electrically connected to the touch power terminal Touch Power. The second end of the third resistor R3 is further electrically connected to a first end of a fourth resistor R4, and a second end of the fourth resistor R4 is electrically connected to the voltage terminal GND.

In embodiments of the present disclosure, the first resistor R1 and the second resistor R2 may be used to divide a voltage of the display power signal Display Power provided by the display power terminal Display Power. The third resistor R3 and the fourth resistor R4 may be used to divide the voltage of the touch power signal Touch Power provided by the touch power terminal Touch Power. This may avoid a short circuit in the signal control sub-circuit 814 when the display power terminal Display Power and/or the touch power signal Touch Power are/is in the power-on state.

For example, the first resistor R1 and the third resistor R3 may have a resistance of 4.7 KΩ, and the second resistor R2 and the fourth resistor R4 may have a resistance of 200 KΩ. The present disclosure does not limit the resistance of the first resistor R1, the second resistor R2, the third resistor R3 and the fourth resistor R4.

In embodiments of the present disclosure, the signal control sub-circuit 814 may output an electrical signal having a high level or a low level according to the power-on state or the power-down state of the display power terminal Display Power. For example, when the display power terminal Display Power is in the power-on state, the signal control sub-circuit 814 may output an electrical signal having a high level to indicate that the display power signal Display Power is output. In this case, a voltage of the electrical signal is consistent with a voltage of the display power signal Display Power output by the display power terminal Display Power. When the display power terminal Display Power is in the power-down state, the signal control sub-circuit 814 may output an electrical signal having a low level to indicate that no display power signal Display Power is output. In this case, the voltage of the electrical signal may be 0 V.

In embodiments of the present disclosure, the signal control sub-circuit 814 may receive the display power signal Display Power and output the control signal GPIO based on the display driving signal Display Power. For example, the power switching sub-circuit may output the touch power signal Touch Power or the display power signal Display Power to the power control sub-circuit based on the control signal GPIO.

For example, when the display power terminal Display Power is in the power-down state, the control signal GPIO output by the signal control sub-circuit 814 has a high level. When the display power terminal Display Power is in the power-on state, the control signal GPIO output by the signal control sub-circuit 814 has a low level.

In embodiments of the present disclosure, the timing control sub-circuit 814 may further receive a control signal GPIO and output a display signal to the source driving circuit based on the control signal GPIO. The source driving circuit may output a data signal based on the display signal.

For example, if it is determined that the control signal GPIO has a high level, the display power terminal Display Power is in the power-down state, and the display panel displays no picture. Therefore, the timing control sub-circuit 814 may output a display signal so that the source driving circuit outputs a data signal to control a display screen of the display panel to be all black, thereby reducing an operation loss of the source driving circuit. For example, a voltage of the data signal may indicate a grayscale value of 0.

In embodiments of the present disclosure, under the control of the control signal GPIO, the timing control sub-circuit 814 may further output a clock control signal. The clock control signal is used to control an output state of the clock signal. For example, if it is determined that the control signal GPIO has a high level, the timing control sub-circuit 814 may turn off the clock signal in the display panel based on the clock control signal. For example, it is possible to turn off the clock signal in the gate driving circuit so that the gate driving circuit does not scan pixel units in the display panel, which may reduce a loss in the gate driving circuit.

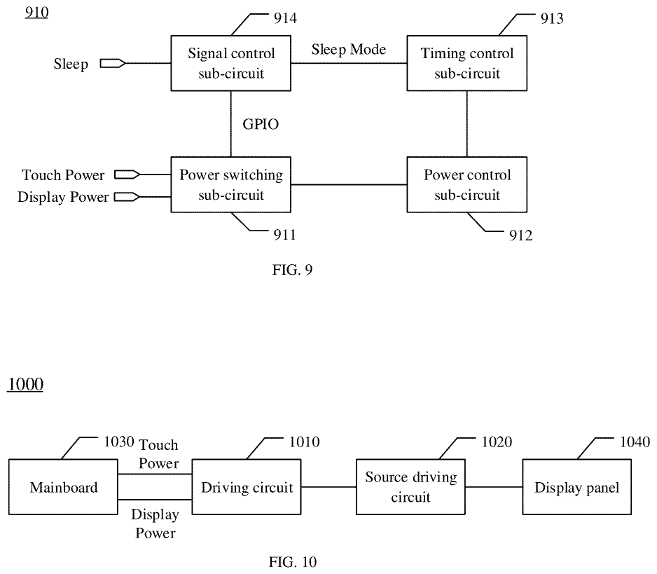

FIG. 9 shows a schematic structural diagram of a driving circuit according to another embodiment of the present disclosure.

As shown in FIG. 9, a driving circuit 910 includes a power switching sub-circuit 911, a power control sub-circuit 912, a timing control sub-circuit 913 and a signal control sub-circuit 914. The power switching sub-circuit 911, the power control sub-circuit 912, the timing control sub-circuit 913 and the signal control sub-circuit 914 are respectively similar to the power switching sub-circuit 711, the power control sub-circuit 712, the timing control sub-circuit 713 and the signal control sub-circuit 714 mentioned above. For the sake of conciseness, the same part will not be repeated in the present disclosure.

In embodiments of the present disclosure, the signal control sub-circuit 914 may receive a sleep signal Sleep, which may come from a mainboard. The sleep signal Sleep may be a signal generated by the mainboard based on a received sleep command. The sleep command may instruct a display driven by the source driving circuit to enter a sleep state. For example, when the mainboard sends the sleep signal Sleep to the signal control sub-circuit 914, the mainboard may control the display power terminal Display Power to enter a power-down state based on the sleep signal Sleep. Then, the display panel may enter the sleep state and turn off the screen.

In an example, although the mainboard controls the display power terminal Display Power to enter the power-down state based on the sleep signal, the touch power terminal Touch Power may be still in the power-on state. Therefore, the power switching sub-circuit 911 may output the touch power signal Touch Power to the power control sub-circuit 912 to supply power to the power control sub-circuit 912. The power control sub-circuit 912 may convert the received touch power signal Touch Power into a timing power signal required for an operation of the timing control sub-circuit 913. As a result, the timing control sub-circuit 913 may output a display signal to the source driving circuit, so that the source driving circuit outputs a data signal to the display panel, then the display panel fails to turn off the screen and fails to enter the sleep state.

In order to overcome the above problems, in embodiments of the present disclosure, the signal control sub-circuit 914 may receive the sleep signal Sleep and output the control signal GPIO based on the sleep signal Sleep. At this time, the signal control sub-circuit 914 may control the control signal GPIO to have a low level based on the sleep signal Sleep. The signal control sub-circuit 914 may output the control signal GPIO having the low level to the power switching sub-circuit 911. Under the control of the control signal GPIO having the low level, the power switching sub-circuit 911 may be in the off state. In this case, the power switching sub-circuit 911 may fail to output the received touch power signal Touch Power to the power control sub-circuit 912, and the power control sub-circuit 912 may fail to operate normally, so that the timing control sub-circuit 913 may fail to drive the source driving circuit. Therefore, under the control of the sleep signal Sleep, the display panel may enter the sleep state.

For example, in the embodiment shown in FIG. 8, the signal control sub-circuit 814 may output a control signal GPIO having a corresponding level based on a signal output state of the display power terminal Display Power. For example, when the display power terminal Display Power is in the power-down state, the control signal GPIO output by the signal control sub-circuit 814 has a high level. When the display power terminal Display Power is in the power-on state, the control signal GPIO output by the signal control sub-circuit 814 has a low level.

In embodiments of the present disclosure, the sleep signal Sleep has a higher priority than the signal output state of the display power terminal Display Power. When the signal control sub-circuit 914 receives the sleep signal Sleep, the signal control sub-circuit 914 controls the control signal GPIO to have a low level only based on the sleep signal Sleep, so as to control the power switching sub-circuit 911 not to output the touch power signal Touch Power and the display power signal Display Power.

For example, referring back to FIG. 6A, although the display power terminal Display Power is in the power-down state, the control signal GPIO may have a low level when the signal control sub-circuit receives the sleep signal Sleep.

The first transistor M1 is a PMOS transistor and the second transistor M2 is an NMOS transistor. Under the control of the low level of the control signal GPIO, the first transistor M1 is in the on state and the second transistor M2 is in the off state. Although the first transistor M1 is in the on state, the display power signal Display Power may not be applied to the power control sub-circuit 612 through the first transistor M1 because the display power terminal Display Power is in the power-down state.

When the second transistor M2 is in the off state, because the display power terminal Display Power is in the power-off state, the gate voltage of the third transistor M3 and the gate voltage of the fourth transistor M4 are in a float state, and the third transistor M3 and the fourth transistor M4 are in the off state. Therefore, the touch power signal Touch Power may not be applied to the power control sub-circuit 612 through the third transistor M3 and the fourth transistor M4.

In this case, the second transistor M2, the third transistor M3 and the fourth transistor M4 are all in the off state, and the first transistor M1 is in the on state. Therefore, when the display power terminal Display Power is in the power-down state and the touch power terminal Touch Power is in the power-on state, neither the touch power signal Touch Power nor the display power signal Display Power may be output to the power control sub-circuit 612. As a result, the display panel may enter the sleep state.

In embodiments of the present disclosure, the signal control sub-circuit 914 may further receive a sleep end signal. After the signal control sub-circuit 914 receives the sleep end signal, the signal control sub-circuit 914 may control the level of the control signal GPIO based on the signal output state of the display power terminal Display Power. For example, when the display power terminal Display Power is in the power-down state, the control signal GPIO output by the signal control sub-circuit 914 has a high level, and when the display power terminal Display Power is in the power-on state, the control signal GPIO output by the signal control sub-circuit 914 has a low level.

In embodiments of the present disclosure, the signal control sub-circuit 914 may receive the sleep signal Sleep and further output a sleep mode signal Sleep Mode based on the sleep signal Sleep. The timing control sub-circuit 913 may output a display signal to the source driving circuit based on the sleep mode signal Sleep Mode. The display signal is used to control the source driving circuit to output a data signal, and the display signal controls the data signal to indicate a grayscale value of 0.

For example, under the control of the sleep mode signal Sleep Mode, the timing control sub-circuit 913 may control the display panel to display no picture or display a black picture. Therefore, the timing control sub-circuit 914 may output a display signal so that the source driving circuit outputs a data signal to control the display screen of the display panel to be all black, thereby reducing the operation loss of the source driving circuit. For example, the voltage of the data signal may indicate a grayscale value of 0.

In embodiments of the present disclosure, the signal control sub-circuit 914 may output the sleep mode signal Sleep Mode to the timing control sub-circuit 913 and then control the power switching sub-circuit 911 not to output a power signal. The power switching sub-circuit 911 may control the display panel to enter the sleep state after the timing control sub-circuit 913 controls the display panel to display a black screen based on the sleep mode signal Sleep Mode, so as to avoid a problem of flickering when the display panel switches from a normal display screen to a black screen.

FIG. 10 shows a schematic structural diagram of a display device according to an embodiment of the present disclosure.

As shown in FIG. 10, a display device 1000 includes a driving circuit 1010, a source driving circuit 1020, a mainboard 1030 and a display panel 1040.

In embodiments of the present disclosure, the mainboard 1030 may output a display power signal and a touch power signal. For example, the mainboard 1030 may be used as a display power terminal Display Power to provide a display power signal Display Power and as a touch power terminal Touch Power to provide a touch power signal Touch Power.

In embodiments of the present disclosure, the driving circuit 1010 is electrically connected to the mainboard 1030. The driving circuit 1010 may output a source power signal 1020 based on the display power signal or the touch power signal. For example, the driving circuit 1010 may be any one of the driving circuit 110, the driving circuit 210, the driving circuit 310, the driving circuit 410, the driving circuit 510, the driving circuit 610a or the driving circuit 710 mentioned above, which will not be described in detail here.

In embodiments of the present disclosure, the source driving circuit 1020 is electrically connected to the driving circuit 1010. The source driving circuit 1020 may output a data signal under the control of the source power signal. The display panel 1040 is electrically connected to the source driving circuit 1020, and the display panel 1040 may display a picture based on the data signal.

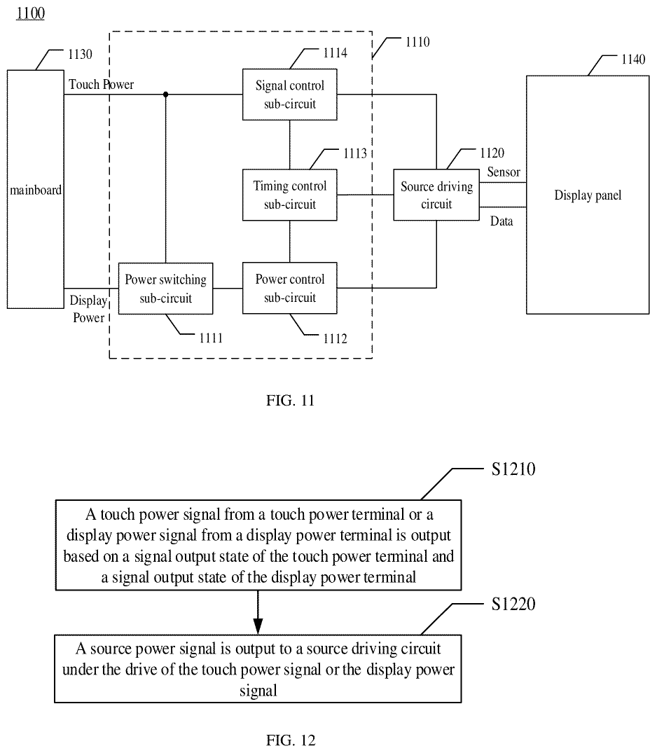

FIG. 11 shows a schematic structural diagram of a display device according to another embodiment of the present disclosure.

As shown in FIG. 11, a display device 1100 includes a driving circuit 1110, a source driving circuit 1120, a mainboard 1130 and a display panel 1140. The driving circuit 1110, the source driving circuit 1120, the mainboard 1130 and the display panel 1140 are respectively similar to the driving circuit 1010, the source driving circuit 1020, the mainboard 1030 and the display panel 1040 mentioned above. For the sake of conciseness, the same part will not be repeated in the present disclosure.

In embodiments of the present disclosure, the driving circuit 1110 includes a power switching sub-circuit 1111, a power control sub-circuit 1112, a timing control sub-circuit 1113 and a signal control sub-circuit 1114. The power switching sub-circuit 1111, the power control sub-circuit 1112, the timing control sub-circuit 1113 and the signal control sub-circuit 1114 are respectively similar to the power switching sub-circuit 711, the power control sub-circuit 712, the timing control sub-circuit 713 and the signal control sub-circuit 714 mentioned above. For the sake of conciseness, the same part will not be repeated in the present disclosure.

In embodiments of the present disclosure, the power switching sub-circuit 1111 may output the touch power signal Touch Power or the display power signal Display Power to the power control sub-circuit 1112. The power control sub-circuit 1112 may convert the received power signal into a timing power signal required for an operation of the timing control sub-circuit 1113 and a source power signal required for an operation of the source driving circuit 1120. The touch power terminal Touch Power may directly output the touch power signal Touch Power to the signal control sub-circuit 1114 for an operation of the signal control sub-circuit 1114.

In embodiments of the present disclosure, the timing control sub-circuit 1113 may output a display signal to the source driving circuit 1120. The source driving circuit 1120 may generate a data signal Data based on the display signal, and the display panel 1140 may display a picture based on the data signal Data.

In embodiments of the present disclosure, the display panel 1140 may generate a sensor signal Sensor in response to a received touch operation. Based on different touch operations, the sensor signal Sensor may have corresponding voltage values. The source driving circuit 1120 may collect the sensor signal and output a touch signal to the driving circuit 1110 based on the sensor signal Sensor. The driving circuit 1110 may receive and process the touch signal to obtain information related to the touch operation. For example, the information related to the touch operation may include position information of the touch operation.

FIG. 12 shows a flowchart of a driving method according to an embodiment of the present disclosure.

As shown in FIG. 12, the driving method may include operation S1210 to operation S1220.

In operation S1210, a touch power signal from a touch power terminal or a display power signal from a display power terminal is output based on a signal output state of the touch power terminal and a signal output state of the display power terminal.

In operation S1220, a source power signal is output to a source driving circuit under the drive of the touch power signal or the display power signal.

In embodiments of the present disclosure, operation S1210 to operation S1220 are similar to the operations performed by the driving circuit 110 described above, which will not be repeated here.

In embodiments of the present disclosure, outputting the touch power signal from the touch power terminal or the display power signal from the display power terminal based on the signal output state of the touch power terminal and the signal output state of the display power terminal may include: outputting the display power signal if it is determined that the touch power signal and the display power signal are received; outputting the touch power signal if it is determined that only the touch power signal is received; and outputting the display power signal if it is determined that only the display power signal is received.

In embodiments of the present disclosure, outputting the touch power signal from the touch power terminal or the display power signal from the display power terminal based on the signal output state of the touch power terminal and the signal output state of the display power terminal may include: outputting the control signal based on the signal output state of the touch power terminal and the signal output state of the display power terminal; and outputting the display power signal or the touch power signal under the control of the control signal.

In embodiments of the present disclosure, outputting the control signal based on the signal output state of the touch power terminal and the signal output state of the display power terminal may include: outputting a control signal having a first level if it is determined that the touch power signal and the display power signal are received; outputting a control signal having a second level if it is determined that only the touch power signal is received; and outputting a control signal having a first level if it is determined that only the display power signal is received.

For example, the first level is a low level, and the second level is a high level.

In embodiments of the present disclosure, outputting the display power signal or the touch power signal under the control of the control signal may include: outputting the display power signal if it is determined that the control signal has the first level; and outputting the touch power signal if it is determined that the control signal has the second level.

In embodiments of the present disclosure, the driving method may further include: outputting a display signal under the control of the control signal, where the display signal is used to control the source driving circuit to output a data signal; where the display signal controls the data signal to indicate a grayscale value of 0 if it is determined that the control signal has the second level.

In embodiments of the present disclosure, the driving method may further include: outputting a clock control signal under the control of the control signal, where the clock control signal is used to control an output state of the clock signal; where the clock signal is turned off based on the clock control signal if it is determined that the control signal has the second level.

In embodiments of the present disclosure, the driving method may further include: outputting a control signal having a first level based on a received sleep signal, where the sleep signal indicates that the display power terminal outputs no display power signal.

In embodiments of the present disclosure, the driving method may further include: outputting a sleep mode signal based on a received sleep signal; and outputting a display signal under the control of the sleep mode signal, where the display signal is used to control the source driving circuit to output a data signal; where the display signal controls the data signal to indicate a grayscale value of 0 under the control of the sleep mode signal.

In embodiments of the present disclosure, the driving method may further include: outputting a timing power signal under the drive of the touch power signal or the display power signal; outputting a synchronization signal under the drive of the timing power signal; and outputting a switching signal based on the synchronization signal, where the switching signal is used to control the source driving circuit to switch between a display driving mode and a touch driving mode.

The flowcharts and block diagrams in the accompanying drawings illustrate the possible architecture, functions and operations of the system, method and computer program product according to various embodiments of the present disclosure. In this regard, each block in the flowcharts or block diagrams may represent a part of a module, a program segment or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that various embodiments of the present disclosure and/or the features described in the claims may be combined in various ways, even if such combinations are not explicitly described in the present disclosure. In particular, without departing from the spirit and teachings of the present disclosure, various embodiments of the present disclosure and/or the features described in the claims may be combined in various ways. All these combinations fall within the scope of the present disclosure.

Embodiments of the present disclosure have been described above. However, these embodiments are for illustrative purposes only, and are not intended to limit the scope of the present disclosure. Although the embodiments have been described separately above, it does not mean that measures in the separate embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A driving circuit for driving a source driving circuit, comprising:
a power switching sub-circuit, electrically connected to a touch power terminal and a display power terminal, wherein the power switching sub-circuit is configured to output a touch power signal from the touch power terminal or a display power signal from the display power terminal based on a signal output state of the touch power terminal and a signal output state of the display power terminal; and
a power control sub-circuit, electrically connected to the power switching sub-circuit and the source driving circuit, wherein the power control sub-circuit is configured to output a source power signal to the source driving circuit under driving of the touch power signal or the display power signal.

2. The driving circuit of claim 1, wherein the power switching sub-circuit is configured to:
output the display power signal in response to determining that the touch power signal and the display power signal are received;
output the touch power signal in response to determining that only the touch power signal is received; and
output the display power signal in response to determining that only the display power signal is received.

3. The driving circuit of claim 1, wherein the power switching sub-circuit comprises a display driving unit and a touch driving unit;
wherein the display driving unit is electrically connected to the display power terminal, the power control sub-circuit and a control signal terminal, and the display driving unit is configured to output the display power signal to the power control sub-circuit under the control of a control signal from the control signal terminal; and
wherein the touch driving unit is electrically connected to the touch power terminal, the power control sub-circuit and the control signal terminal, and the touch driving unit is configured to output the touch power signal to the power control sub-circuit under the control of the control signal.

4. The driving circuit of claim 3, wherein the display driving unit comprises a first transistor; and
wherein the first transistor has a gate electrode electrically connected to the control signal terminal, a drain electrode electrically connected to the display power terminal, and a source electrode electrically connected to the power control sub-circuit.

5. The driving circuit of claim 3, wherein the touch driving unit comprises a second transistor, a third transistor and a fourth transistor;
wherein the second transistor has a gate electrode electrically connected to the control signal terminal, a drain electrode electrically connected to a gate electrode of the fourth transistor, and a source electrode electrically connected to a voltage terminal;
wherein the third transistor has a gate electrode electrically connected to the gate electrode of the fourth transistor, a drain electrode electrically connected to the power control sub-circuit, and a source electrode electrically connected to a source electrode of the fourth transistor; and
wherein the gate electrode and a drain electrode of the fourth transistor are electrically connected to the touch power terminal.

6. The driving circuit of claim 3, wherein the touch driving unit is further electrically connected to the display power terminal, and the touch driving unit is configured to output the touch power signal to the power control sub-circuit under the control of the control signal and the display power signal.

7. The driving circuit of claim 6, wherein the touch driving unit comprises a second transistor and a third transistor;
wherein the second transistor has a gate electrode electrically connected to the control signal terminal, a drain electrode electrically connected to the display power terminal, and a source electrode electrically connected to a voltage terminal; and
wherein the third transistor has a gate electrode electrically connected to the display power terminal, a drain electrode electrically connected to the power control sub-circuit, and a source electrode electrically connected to the touch power terminal.

8. The driving circuit of claim 6, wherein the touch driving unit comprises a second transistor, a third transistor and a fourth transistor;
wherein the second transistor has a gate electrode electrically connected to the control signal terminal, a drain electrode electrically connected to the display power terminal, and a source electrode electrically connected to a voltage terminal;
wherein the third transistor has a gate electrode electrically connected to the display power terminal, a drain electrode electrically connected to the power control sub-circuit, and a source electrode electrically connected to a source electrode of the fourth transistor; and
wherein the fourth transistor has a gate electrode electrically connected to the display power terminal, and a drain electrode electrically connected to the touch power terminal.

9. The driving circuit of claim 1, further comprising:
a timing control sub-circuit, electrically connected to the power control sub-circuit and the source driving circuit, wherein the timing control sub-circuit is configured to output a synchronization signal under driving of a timing power signal from the power control sub-circuit; and
a signal control sub-circuit, electrically connected to the timing control sub-circuit, the source driving circuit and the touch power terminal, wherein the signal control sub-circuit is configured to receive the touch power signal and output a switching signal based on the synchronization signal under driving of the touch power signal, and the switching signal is configured to control the source driving circuit to switch between a display driving mode and a touch driving mode;
wherein the power control sub-circuit is further configured to output the timing power signal to the timing control sub-circuit under driving of the touch power signal or the display power signal.

10. The driving circuit of claim 9, wherein the signal control sub-circuit is further configured to receive the display power signal and output a control signal based on the display driving signal; and
wherein the power switching sub-circuit is further configured to output the touch power signal or the display power signal to the power control sub-circuit based on the control signal.

11. The driving circuit of claim 10, wherein the timing control sub-circuit is further configured to receive the control signal and output a display signal to the source driving circuit based on the control signal.

12. The driving circuit of claim 9, wherein the signal control sub-circuit is further configured to receive a sleep signal and output a control signal based on the sleep signal; and
wherein the power switching sub-circuit is configured to enter an off state based on the control signal.

13. The driving circuit of claim 9, wherein the signal control sub-circuit is further configured to receive a sleep signal and output a sleep mode signal based on the sleep signal; and
wherein the timing control sub-circuit is configured to output a display signal to the source driving circuit based on the sleep mode signal, the display signal is configured to control the source driving circuit to output a data signal, and the data signal is controlled by the display signal to indicate a grayscale value of 0.

14. A display device, comprising:
a mainboard configured to output a display power signal and a touch power signal;
the driving circuit of claim 1, electrically connected to the mainboard, wherein the driving circuit is configured to output a source power signal based on the display power signal or the touch power signal;
a source driving circuit electrically connected to the driving circuit, wherein the source driving circuit is configured to output a data signal under the control of the source power signal; and
a display panel electrically connected to the source driving circuit, wherein the display panel is configured to display a picture based on the data signal.

15. The display device of claim 14, wherein,
the display panel is further configured to generate a sensor signal in response to a touch operation being received;
the source driving circuit is further configured to collect the sensor signal and output a touch signal based on the sensor signal; and
the driving circuit is further configured to receive and process the touch signal to obtain information related to the touch operation.

16. A driving method applied to the driving circuit of claim 1, comprising:
outputting a touch power signal from a touch power terminal or a display power signal from a display power terminal based on a signal output state of the touch power terminal and a signal output state of the display power terminal; and
outputting a source power signal to a source driving circuit under driving of the touch power signal or the display power signal.

17. The driving method of claim 16, wherein the outputting a touch power signal from a touch power terminal or a display power signal from a display power terminal based on a signal output state of the touch power terminal and a signal output state of the display power terminal comprises:
outputting the display power signal in response to determining that the touch power signal and the display power signal are received;
outputting the touch power signal in response to determining that only the touch power signal is received; and
outputting the display power signal in response to determining that only the display power signal is received.

18. The driving method of claim 16, wherein the outputting a touch power signal from a touch power terminal or a display power signal from a display power terminal based on a signal output state of the touch power terminal and a signal output state of the display power terminal comprises:
outputting a control signal based on the signal output state of the touch power terminal and the signal output state of the display power terminal; and
outputting the display power signal or the touch power signal under the control of the control signal,
wherein the outputting a control signal based on the signal output state of the touch power terminal and the signal output state of the display power terminal comprises:
outputting the control signal having a first level in response to determining that the touch power signal and the display power signal are received;
outputting the control signal having a second level in response to determining that only the touch power signal is received; and
outputting the control signal having the first level in response to determining that only the display power signal is received.
wherein the outputting the display power signal or the touch power signal under the control of the control signal comprises:
outputting the display power signal in response to determining that the control signal has the first level; and
outputting the touch power signal in response to determining that the control signal has the second level; and
wherein the driving method further comprises:
outputting a display signal under the control of the control signal, wherein the display signal is configured to control the source driving circuit to output a data signal, and the data signal is controlled by the display signal to indicate a grayscale value of 0 when it is determined that the control signal has the second level; and
outputting a clock control signal under the control of the control signal, wherein the clock control signal is configured to control an output state of a clock signal, and the clock signal is turned off based on the clock control signal when it is determined that the control signal has the second level.

19-22. (canceled)

23. The driving method of claim 16, further comprising:
outputting a control signal having a first level based on a received sleep signal, wherein the sleep signal indicates that the display power terminal outputs no display power signal;
outputting a sleep mode signal based on a received sleep signal; and
outputting a display signal under the control of the sleep mode signal, wherein the display signal is configured to control the source driving circuit to output a data signal, and the data signal is controlled by the display signal to indicate a grayscale value of 0 under the control of the sleep mode signal.

24. (canceled)

25. The driving method of claim 16, further comprising:
outputting a timing power signal under driving of the touch power signal or the display power signal;
outputting a synchronization signal under driving of the timing power signal; and
outputting a switching signal based on the synchronization signal, wherein the switching signal is configured to control the source driving circuit to switch between a display driving mode and a touch driving mode.
